(19) United States
(12) Patent Application Publication
(10) Pub. No.: US 2023/0295820 A1
(43) Pub. Date: Sep. 21, 2023

(54) ANODE-SIDE SEPARATOR AND WATER ELECTROLYZER

(71) Applicant: TOYOTA JIDOSHA KABUSHIKI KAISHA, Toyota-shi (JP)

(72) Inventors: Joji Yoshimura, Toyota-shi (JP); Hiromochi Tanaka, Toyota-shi (JP); Tomonari Kogure, Toyota-shi (JP); Mizuki Sakamoto, Toyota-shi (JP); Masaki Hirano, Tsushima-shi (JP)

(73) Assignee: TOYOTA JIDOSHA KABUSHIKI KAISHA, Toyota-shi (JP)

(21) Appl. No.: 18/155,931

(22) Filed: Jan. 18, 2023

(30) Foreign Application Priority Data
Mar. 17, 2022 (JP) 2022-043200

(51) Int. Cl. C25B 13/05; C25B 1/04

(52) U.S. Cl. CPC C25B 13/05; C25B 1/04

(57) ABSTRACT

The anode-side separator of the present disclosure is an anode-side separator used in a water electrolyzer, and includes a metal substrate made of titanium or stainless steel, and a conductive oxide film containing indium-tin-oxide (ITO) provided on the surface of the metal substrate.

### CROSS-REFERENCE TO RELATED APPLICATION

This application claims priority to Japanese Patent Application No. 2022-043200 filed on Mar. 17, 2022, incorporated herein by reference in its entirety.

### BACKGROUND

### 1. Technical Field

The present disclosure relates to an anode-side separator used in a water electrolyzer and a water electrolyzer including the anode-side separator.

### 2. Description of Related Art

In recent years, as a water electrolyzer for producing hydrogen gas by electrolyzing water or the like as a raw material, a water electrolyzer in which water electrolysis cells that electrolyze water or the like and use a solid electrolyte membrane such as a solid polymer electrolyte are arranged in a predetermined number of sets have been employed. The water electrolysis cell is, for example, a unit in which an anode catalyst layer and a cathode catalyst layer are provided on one surface and the other surface of a solid polymer electrolyte membrane, respectively, an anode power feeder and an anode-side separator are laminated on the anode catalyst layer, and a cathode power feeder and a cathode side separator are laminated on the cathode catalyst layer.

The anode-side separator used in the water electrolyzer defines a passage for supplying water or the like as the raw material to the surface of the anode catalyst layer, and functions as a partition plate for separating the hydrogen gas and the oxygen gas generated by the water electrolysis and also functions as a current-carrying member that transmits electricity to the anode catalyst layer. Therefore, the anode-side separator is required to have excellent conductivity. Further, the anode-side separator often uses a metal substrate from the viewpoint of strength and the like. However, since the metal substrate is susceptible to corrosion, corrosion resistance may be problematic when the metal substrate is employed. In order to address this problem, an anode-side separator in which a conductive layer having excellent conductivity and corrosion resistance is provided on the surface of the metal substrate is employed.

As such an anode-side separator, for example, an anode separator described in Japanese Unexamined Patent Application Publication No. 2018-127707 (JP 2018-127707 A) is known. The anode separator includes a metal substrate consisting of at least one of titanium and a titanium alloy and a titanium member that includes a noble metal layer (conductive layer) made of Au and that is directly laminated on the metal substrate. When the titanium member is fabricated, the noble metal layer made of Au is formed by applying plating to the surface of the metal substrate. In order to ensure adhesion of plating to the surface of the metal substrate, a treatment for roughening the surface of the metal substrate is applied. With the above, the anode separator has high conductivity and high durability that can be used in an electrolysis cell (a water electrolysis cell) or the like in a water electrolyzer, and can improve the adhesiveness and the coverage rate between the metal substrate and the noble metal layer as a result that the arithmetic mean roughness Ra of the surface of the metal substrate on which the noble metal layer is formed is set to a specified range.

On the other hand, as a member different from the anode-side separator although the member is a member constituting the anode used for water electrolysis, a member constituting the anode of a bubble generator described in Japanese Unexamined Patent Application Publication No. 2013-231208 (JP 2013-231208 A) is known, for example. The member constituting the anode includes an electrode substrate made of a metal such as aluminum, an aluminum alloy, platinum, or gold, and a conductive oxide film provided on the surface of the electrode substrate and forming a nanostructure.

### SUMMARY

In the anode separator described in JP 2018-127707 A, the noble metal layer made of Au is provided on the surface of the metal substrate. Therefore, while the anode is excellent in corrosion resistance, the material cost becomes very high, whereby it is difficult to operate the anode in a water electrolyzer as an actual product. Therefore, use of a separator in which a conductive oxide film is provided on the surface of the metal substrate made of a metal such as aluminum, similar to the member described in JP 2013-231208 A, is studied as the anode-side separator in which the conductive layer is provided on the surface of the metal substrate as described above. However, in the water electrolyzer, when water or the like as the raw material is electrolyzed, a high voltage of, for example, about 1.8 V is normally applied to the water electrolysis cell, and the anode-side separator is exposed to a high voltage environment. In such a situation, when the anode-side separator in which the conductive oxide film is provided on the surface of the metal substrate made of a metal such as aluminum is used, the corrosion resistance is problematic.

The present disclosure has been made in view of such a point, and an object thereof is to provide an anode-side separator used in a water electrolyzer and a water electrolyzer including the anode-side separator, and an anode-side separator and a water electrolyzer capable of improving corrosion resistance and reducing material cost.

In order to solve the above problem, an anode-side separator according to the present disclosure is an anode-side separator used in a water electrolyzer, and includes: a metal substrate consisting of titanium or stainless steel; and a conductive oxide film including indium-tin-oxide (ITO) provided on a surface of the metal substrate.

Further, a water electrolyzer according to the present disclosure includes the above-described anode-side separator.

According to the present disclosure, the corrosion resistance can be increased and the material cost can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded cross-sectional view schematically showing a configuration of a water electrolysis cell which is a structural unit of a water electrolyzer according to a first embodiment including an anode-side separator according to a first embodiment;

FIG. 2 is an enlarged view of the X portion of FIG. 1, and is a cross-sectional view schematically illustrating a main part of the anode-side separator according to the first embodiment;

FIG. 3A is a photograph of the test specimen prior to the corrosion resistance test;

FIG. 3B is a photograph of the test specimen after corrosion resistance test 1;

FIG. 3C is a photograph of the test specimen after corrosion resistance test 2;

FIG. 3D is a photograph of the test specimen after corrosion resistance test 3;

FIG. 3E is a photograph of the test specimen after corrosion resistance test 4;

FIG. 4 is an optical micrograph of one principal surface of a plate-shaped metal substrate made of pure titanium used in the preparation of the anode-side separator in Examples;

FIG. 5A is a roughness curve of one portion of one main surface of a plate-shaped metallic substrate made of pure titanium used in the preparation of the anode-side separators in the embodiment;

FIG. 5B is a roughness curve at a point that differs from 5A of the drawing of one main surface of the plate-shaped metallic substrate made of pure titanium used in the production of the anode-side separator in the embodiment.

### DETAILED DESCRIPTION OF EMBODIMENTS

Hereinafter, embodiments of the anode-side separator and the water electrolyzer of the present disclosure will be described.

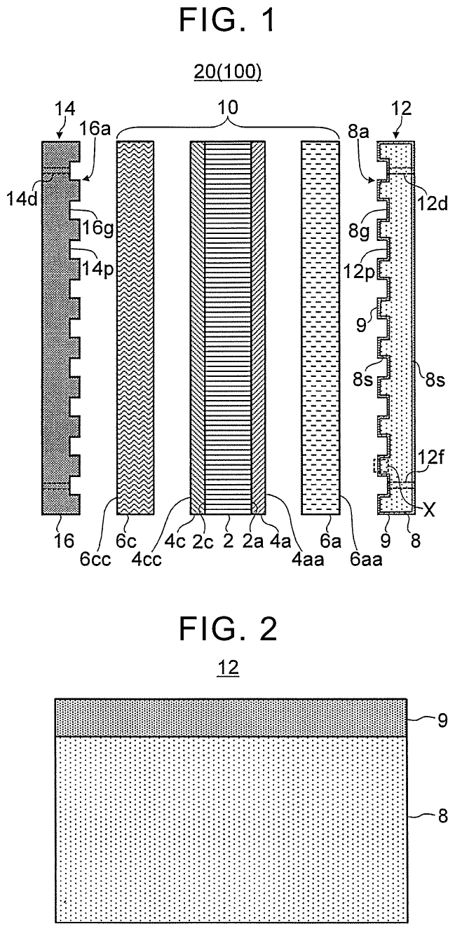

First, an outline of the anode-side separator and the water electrolyzer according to the embodiment will be described by exemplifying the anode-side separator and the water electrolyzer according to the first embodiment. FIG. 1 is an exploded cross-sectional view schematically showing a configuration of a water electrolysis cell which is a structural unit of a water electrolyzer according to a first embodiment including an anode-side separator according to a first embodiment. FIG. 2 is an enlarged view of a portion X of FIG. 1, and is a cross-sectional view schematically showing a main part of the anode-side separator according to the first embodiment.

As shown in FIG. 1, the water electrolyzer 100 according to the first embodiment is configured by stacking a plurality of sets of water electrolysis cells 20. The water electrolysis cell 20 is a solid polymer water electrolysis cell including the membrane electrode assembly 10, and the anode-side separator 12 and the cathode-side separator 14 according to the first embodiment sandwiching the membrane electrode assembly 10.

The membrane electrode assembly 10 includes a solid polymer electrolyte membrane 2, an anode catalyst layer 4a and a cathode catalyst layer 4c provided on one main surface 2a and the other main surface 2c of the solid polymer electrolyte membrane 2, respectively, an anode power feeder 6a laminated on the main surface 4aa of the anode catalyst layer 4a, and a cathode power feeder 6c laminated on the main surface 4cc of the cathode catalyst layer 4c. The anode-side separator 12 is laminated on the main surface 6aa of the anode power feeder 6a, and the cathode-side separator 14 is laminated on the main surface 6cc of the cathode power feeder 6c.

As shown in FIGS. 1 and 2, the anode-side separator 12 includes a metal substrate 8 made of pure titanium and a conductive oxide film 9 containing indium-tin oxide (ITO) provided on the entire surface 8s of the metal substrate 8. In the anode-side separator 12, a fluid passage 12p is provided by providing a groove 8g for a fluid passage on a main surface 8a of the metal substrate 8 facing the solid polymer electrolyte membrane 2, and a water supply port 12f and a water drain port 12d communicating with the fluid passage 12p are provided. The cathode-side separator 14 includes a metal substrate 16 made of aluminum. In the cathode-side separator 14, a fluid passage 14p is provided by providing a groove 16g for a fluid passage on a main surface 16a of the metal substrate 16 facing the solid polymer electrolyte membrane 2, and a hydrogen-outlet 14d communicating with the fluid passage 14p is provided. The anode-side separator 12 and the cathode-side separator 14 serve as a current-carrying member that transmits electricity to the anode catalyst layer 4a and the cathode catalyst layer 4c via the anode power feeder 6a and the cathode power feeder 6c, respectively, and electrically connects to neighboring water electrolysis cells (not shown). In the water electrolyzer 100, a plurality of sets of water electrolysis cells 20 are stacked in the opposite directions of the anode-side separator 12 and the cathode-side separator 14, and are fastened by end plates (not shown) from both sides in the stacking direction.

When hydrogen gas is produced by electrolyzing the raw material water by using the water electrolyzer 100, the raw material water is first supplied from the water supply port 12f of the anode-side separator 12 to the fluid passage 12p. At the same time, the anode-side separator 12 and the cathode-side separator 14 transmit electricity to the anode catalyst layer 4a and the cathode catalyst layer 4c via the anode power feeder 6a and the cathode power feeder 6c, respectively. As a result, hydrogen ions (H⁺), electrons, and oxygen gases (O²) are generated by electrolyzing the raw material water in the anode catalyst layer 4a. Next, the hydrogen ions permeate through the polymer electrolyte membrane 2, which is a cation permeable membrane, by the potential difference between the anode catalyst layer 4a and the cathode catalyst layer 4c, and move from the anode catalyst layer 4a to the cathode catalyst layer 4c. Hydrogen gas (H²) is obtained in the fluid passage 14p of the cathode-side separator 14 by receiving electrons from the cathode catalyst layer 4c and molecularizing the hydrogen ions. The hydrogen gases are extracted from the hydrogen outlet 14d. On the other hand, the oxygen-gas obtained in the fluid-passage 12p of the anode-side separator 12 is discharged from the water drain port 12d together with most of the raw material water.

The effects of the anode-side separator 12 and the water electrolyzer 100 as described above will be described.

Here, as in the prior art, in the water electrolyzer 100, in place of the anode-side separator 12 according to the first embodiment, a problem of a water electrolyzer using an anode-side separator in which a conductive oxide film containing indium tin oxide is provided on a surface of a metal substrate made of a general-purpose metal other than titanium and stainless steel (for example, aluminum or the like) will be described. In the water electrolyzer, in general, when an anode-side separator in which a conductive oxide film is provided on a surface of a metal substrate is used, since the conductive oxide film is a porous body, the raw material water supplied to the fluid passage permeates the conductive oxide film, and as a result, the conductive oxide film containing different metals and the metal substrate come into contact with each other in the raw material water. As a result, a corrosive battery is formed between the conductive oxide film and the metal substrate and the raw material water, so that an electric current flows, and dissimilar metal contact corrosion occurs. Further, in the water electrolyzer, when the raw material water is electrolyzed, a high voltage of, for example, about 1.8V is normally applied to the water electrolysis cell of the constituent units, so that the anode-side separators are exposed to a high voltage environment. In such a situation, when an anode-side separator in which a general-purpose metal other than titanium and stainless steel is used as a metal substrate is used, since the general-purpose metal other than titanium and stainless steel is not sufficiently corrosion resistant, corrosion of the metal substrate due to dissimilar metal contact corrosion is promoted, and corrosion resistance of the anode-side separator becomes a problem.

On the other hand, in the anode-side separator 12 according to the first embodiment, the pure titanium used for the metal substrate 8 has significantly higher corrosion resistance than general-purpose metals other than titanium and stainless steel. Therefore, in the water electrolyzer 100 according to the first embodiment, in the anode-side separator 12, the conductive oxide film 9 and the metal substrate 8 containing different metals are in contact with each other in the raw material water, and, for example, even in a situation where the anode-side separator 12 is exposed to a high-voltage environment by applying a high voltage of about 1.8V to the water electrolysis cell, corrosion of the metal substrate 8 due to the different metal contact corrosion can be suppressed.

Further, in the anode-side separator 12 according to the first embodiment, the indium tin oxide contained in the conductive oxide film 9 provided as a conductive layer on the surface 8s of the metal substrate 8 is significantly less expensive than the noble metal such as Au contained in the noble metal layer provided as a conductive layer on the surface of the metal substrate in the separator of the prior art. Therefore, in the anode-side separator 12, the material cost can be significantly reduced as compared with the separator of the related art. Further, the anode-side separator 12 is a combination of the metal substrate 8 and the conductive oxide film 9 through which current flows in both, and indium tin oxide contained in the conductive oxide film 9 has a sufficiently low contact resistance and a sufficiently high conductivity. Therefore, according to the anode-side separator 12, the performance of electrolysis of the water electrolyzer 100 can be sufficiently increased.

In the anode-side separator according to the embodiment, as in the first embodiment, a conductive oxide film is provided on the surface of the metal substrate, and titanium or stainless steel is used as the metal substrate. Titanium and stainless steel have significantly higher corrosion resistance than other general-purpose metals. Therefore, in the water electrolyzer according to the embodiment, by providing the anode-side separator according to the embodiment, it is possible to suppress the corrosion of the metal substrate due to the dissimilar metal contact corrosion as in the first embodiment. Further, in the anode-side separator according to the embodiment, the material cost can be significantly reduced as compared with the separator of the prior art as in the first embodiment. Therefore, according to the anode-side separator and the water electrolyzer of the embodiment, the corrosion resistance can be increased and the material cost can be reduced. Furthermore, as in the first embodiment, the performance of electrolysis of the water electrolyzer can be sufficiently increased.

Next, configurations of the anode-side separator and the water electrolyzer according to the embodiment and the method for producing hydrogen gas according to the embodiment will be described in detail.

### 1.Anode-Side Separator

The anode-side separator according to the embodiment is an anode-side separator used in a water electrolyzer, and includes a metal substrate made of titanium or stainless steel, and a conductive oxide film containing indium-tin-oxide (ITO) provided on the surface of the metal substrate. Here, the “surface of the metal substrate” means an outer surface of the metal substrate, and may be one main surface of the metal substrate or the other main surface of the metal substrate. Hereinafter, the metal substrate and the conductive oxide film of the anode-side separator and others will be described in detail.

### (1) Metal Substrate

The titanium used for the metal substrate is not particularly limited, and examples thereof include pure titanium and titanium alloys. Pure titanium is not particularly limited, and examples thereof include those defined in JISH4600:2012. The titanium alloy is not particularly limited, and examples thereof include Ti—Al, Ti—Nb, Ti—Ta, Ti-6A1-4V, Ti—Pd. Among the titanium used for the metal substrate, pure titanium is preferable. This is because the corrosion resistance is particularly high.

Examples of the stainless steel used for the metallic substrate include austenitic stainless steel such as SUS304, SUS316, ferritic stainless steel such as SUS430, and martensitic stainless steel such as SUS420.

The shape of the metal substrate is not particularly limited as long as it is a shape of a general metal substrate constituting an anode-side separator used in a general water electrolyzer, and may be a shape in which a groove for a fluid passage of the separator is provided in the metal substrate. In a case where the water electrolysis device is a water electrolyzer including a solid polymer water electrolysis cell, for example, the metal substrate may have a shape in which a groove for a fluid passage is provided on a main surface side of the metal substrate facing the solid polymer electrolyte membrane, as in the first embodiment. The shape of the metal substrate may be a flat plate shape in which a groove for a fluid passage is not provided in the metal substrate. In the case where the metal substrate has a flat plate shape, the metal substrate constitutes, for example, a flat type separator in which fluid passages are separated. The surface roughness Rz of the metallic substrate is, for example, in the range of 0.05 μm or more and 0.8 μm or less, and preferably in the range of 0.1 μm or more, particularly 0.3 μm or more. The thickness of the metal substrate is not particularly limited, and may be set according to the material of the metal substrate in consideration of strength, processing, and the like, but is within the scope of 0.1 mm to 1 mm, for example.

### (2)Conductive Oxide Film

The conductive oxide film is not particularly limited as long as it is provided on the metallic substrate and contains indium-tin-oxide (ITO). As the conductive oxide film, in the case where the water electrolyzer is a water electrolysis device including a cell for solid polymer type water electrolysis, for example, as in the first embodiment, the conductive oxide film is preferably provided on at least a main surface of the metal substrate facing the solid polymer electrolyte film, and may be provided on the entire surface of the metal substrate.

The thickness of the conductive oxide film is not particularly limited, but is, for example, in the range of 0.05 μm or more and 0.8 μm or less, and preferably in the range of 0.3 μm or more. This is because when the thickness of the conductive oxide film is 0.05 μm or more, the conductive oxide film can be uniformly formed. Further, by the thickness of the conductive oxide film is 0.3 μm or more, when the surface of the metal substrate is roughened by the metal substrate through the pressing process, it is possible to sufficiently secure the corrosion resistance of the anode-side separator. On the other hand, when the thickness of the conductive oxide film is 0.8 μm or less, it is possible to suppress peeling of the conductive oxide film from the metal substrate due to residual stress.

### (3)Method for Manufacturing Anode-Side Separator

A method of manufacturing the anode-side separator is not particularly limited, and examples thereof include a method of forming a conductive oxide film containing indium-tin oxide (ITO) on a surface of a metal substrate by preparing a metal substrate made of titanium or stainless steel and using a sputtering method.

### 2.Water Electrolysis Equipment

The water electrolyzer according to the embodiment is not particularly limited as long as it includes the anode-side separator described above, but is preferably a water electrolyzer including a solid polymer type water electrolysis cell using a solid polymer electrolyte membrane, for example, as in the water electrolyzer according to the first embodiment.

Examples of the solid polymer type water electrolysis cell include a cell for water electrolysis according to the first embodiment including, for example, a membrane electrode assembly and the above-described anode-side separator and cathode-side separator sandwiching the membrane electrode assembly. In the water electrolyzer including such a solid polymer water electrolysis cell, a plurality of sets of water electrolysis cells are usually stacked in the opposite direction of the anode-side separator and the cathode-side separator, and adjacent water electrolysis cells are electrically connected to each other by the anode-side separator and the cathode-side separator. Examples of such a cell for solid polymer type water electrolysis include a cell in which a membrane electrode assembly includes a solid polymer electrolyte membrane, an anode catalyst layer and a cathode catalyst layer respectively provided on one main surface and the other main surface of the solid polymer electrolyte membrane, an anode power feeder laminated on the main surface of the anode catalyst layer, and a cathode power feeder laminated on the main surface of the cathode catalyst layer, an anode-side separator is laminated on the main surface of the anode power feeder, and a cathode-side separator is laminated on the main surface of the cathode power feeder.

The polymer electrolyte membrane has a function of preventing the circulation of electrons and gas, and transferring hydrogen ions (H⁺) from the anode catalyst layer side to the cathode catalyst layer side. The solid polymer electrolyte membrane is not particularly limited, but is made of, for example, an ion-exchange membrane made of a polymer electrolyte resin which is a solid polymer material such as a perfluorosulfonic acid (PFSA) ionomer and having an ion-conductive polymer membrane as an electrolyte.

The anode catalyst layer has a function of generating hydrogen ions, electrons, and oxygen gas from the raw material water. The anode catalyst layer is not particularly limited, but includes, for example, a catalyst layer composed of a catalyst and an ionomer and formed by coating the catalyst with the ionomer. Examples of the catalyst include, but are not limited to, a supported catalyst in which a platinum group metal such as platinum, iridium, or ruthenium, or an alloy thereof is supported on support particles. The carrier particles are not particularly limited, and examples thereof include carbon carrier particles such as carbon black. The ionomer is made of, for example, a polymer electrolyte resin which is a solid polymer material such as a fluorine-based resin having the same quality as that of the solid polymer electrolyte membrane, and has proton conductivity due to the ion exchange group that the polymer electrolyte resin has. Unlike the anode catalyst layer, the cathode catalyst layer has a function of converting hydrogen ions and electrons into hydrogen gas (H²). The cathode catalyst layer is not particularly limited, but includes, for example, a catalyst layer composed of a catalyst and an ionomer and formed by coating the catalyst with the ionomer. The catalyst and ionomer are similar to the catalyst and ionomer of the anode catalyst layer.

Examples of the method for producing the membrane electrode assembly include a method in which the anode catalyst layer and the cathode catalyst layer are formed on one main surface and the other main surface of the solid polymer electrolyte membrane, respectively, and the obtained assembly is further sandwiched between the anode power feeder and the cathode power feeder. Examples of the method for forming the catalyst layer include a method in which the coating liquid for forming the catalyst layer is applied to a predetermined position on the main surface of the solid polymer electrolyte membrane and dried as necessary. The coating liquid for forming a catalyst layer is a liquid obtained by dispersing a catalyst and an ionomer in a dispersion medium.

The anode power feeder and the cathode power feeder are not particularly limited as long as they are conductive members having gas permeability, but are made of, for example, a porous material having conductivity, specifically, a porous metal material such as a sintered body of titanium powder, a porous fiber material such as carbon fiber and graphite fiber, and the like.

The anode-side separator is as described in “1. Anode-side separator” above. Examples of the cathode-side separator include those provided with a metal substrate made of aluminum, stainless steel, titanium, or the like. The shape of the metal substrate included in the cathode-side separator is not particularly limited as long as it is the shape of a general metal substrate constituting a cathode-side separator used in a general water electrolyzer. The thickness of the metal substrate included in the cathode-side separator is not particularly limited, and may be set according to the material of the metal substrate in consideration of strength, processing, and the like, but is within the scope of 0.1 mm to 1 mm, for example.

### 3.Method for Producing Hydrogen Gas

In the method for producing hydrogen gas according to the embodiment, the hydrogen gas is produced by electrolyzing the raw material water by using the water electrolyzer according to the embodiment. The method for producing hydrogen gas is not particularly limited, but a method using raw material water having a pH of 4 or more as the raw material water is preferable. This is because, when the raw material water having a pH of 4 or more is used, the dissolution of indium-tin oxide (ITO) contained in the conductive oxide film of the anode-side separator included in the water electrolyzer can be suppressed, and the contact-resistance of the anode-side separator can be suppressed from increasing.

Hereinafter, the anode-side separator and the water electrolyzer according to the embodiment will be described in more detail with reference to Examples, Comparative Examples, and Reference Examples.

### Examples

First, a flat metal substrate made of pure titanium was prepared. Next, a conductive oxide film containing indium-tin-oxide (ITO) was formed on one main surface of the metallic substrate to a 100 nm thickness by using a sputtering method. At this time, before forming the conductive oxide film, a natural oxide film or the like on one main surface (film forming surface) of the metal substrate was removed by reverse sputtering in advance. Thus, an anode-side separator was produced.

### Measurement of Contact Resistance Before Corrosion Resistance Test

Test samples were cut out from the anode-side separators prepared in the Examples, and the contact-resistance (mΩ·cm² was measured for the test samples prior to the corrosion resistance test. Specifically, a carbon sheet (TGP-H-060 manufactured by Toray Industries, Inc.) was placed on the conductive oxide film-side surface of the test sample, and a constant load (1 MPa) was applied by a measuring tool, so that the current flowing through the test sample by the ammeter was 1A, the current from the power source was adjusted and passed, the voltage applied to the test sample was measured by the voltmeter, and the contact resistance between the test sample and the carbon sheet was calculated.

### Corrosion Resistance Test 1

The anode-side separators prepared in the Examples were subjected to a corrosion resistance test (constant potential corrosion test) according to the electrochemical high-temperature corrosion test method (JISZ2294:2004) of a metallic material of Japanese Industrial Standard. Specifically, a test sample was cut out from the anode-side separator, and the test sample was immersed in a corrosive solution (dilute sulfuric acid aqueous solution) whose temperature was adjusted to 80° C. by the temperature control water and adjusted to pH6 by the sulfuric acid content. In this condition, a potential difference of 1.8V was generated between the counter electrode and the sample electrode by electrically connecting the counter electrode made of a platinum plate and the test sample (sample electrode), and the test sample was corroded. During the test, the potential of the test sample was held constant at the reference electrode. The test time was 60 hours. A HZ-Pro made by Hokuto Denko was used as a test equipment for the test.

For the test sample after the corrosion resistance test, the contact resistance was measured by the same method as the measurement of the contact resistance before the corrosion resistance test.

The amount of indium (In) dissolved from the conductive oxide film of the test sample in the waste liquid of the corrosive liquid used in the corrosion resistance test (μm/L) was measured. Specifically, for the waste liquid of the corrosive liquid, the intensity of the emission from the components of indium was measured using an inductively coupled plasma (ICP) emission analyzer, and then the amount of indium dissolved in the waste liquid of the corrosive liquid was calculated from the measured intensity of the emission.

### Corrosion Resistance Test 2

The anode-side separator prepared in the embodiment was subjected to a corrosion resistance test in the same manner as in the corrosion resistance test 1 except that the corrosion solution was adjusted to pH4. Then, the test sample after the corrosion resistance test, the contact resistance was measured by the same method as in the corrosion resistance test 1. Further, the amount of indium dissolved in the waste liquid of the corrosion liquid used in the corrosion resistance test was measured by the same method as in the corrosion resistance test 1.

### Corrosion Resistance Test 3

The anode-side separator prepared in the embodiment was subjected to a corrosion resistance test in the same manner as in the corrosion resistance test 1 except that the corrosion solution was adjusted to pH3. Then, the test sample after the corrosion resistance test, the contact resistance was measured by the same method as in the corrosion resistance test 1. Further, the amount of indium dissolved in the waste liquid of the corrosion liquid used in the corrosion resistance test was measured by the same method as in the corrosion resistance test 1.

### Corrosion Resistance Test 4

The anode-side separator prepared in the embodiment was subjected to a corrosion resistance test in the same manner as in the corrosion resistance test 1 except that the corrosion solution was adjusted to pH2. Then, the test sample after the corrosion resistance test, the contact resistance was measured by the same method as in the corrosion resistance test 1. Further, the amount of indium dissolved in the waste liquid of the corrosion liquid used in the corrosion resistance test was measured by the same method as in the corrosion resistance test 1.

### Evaluation

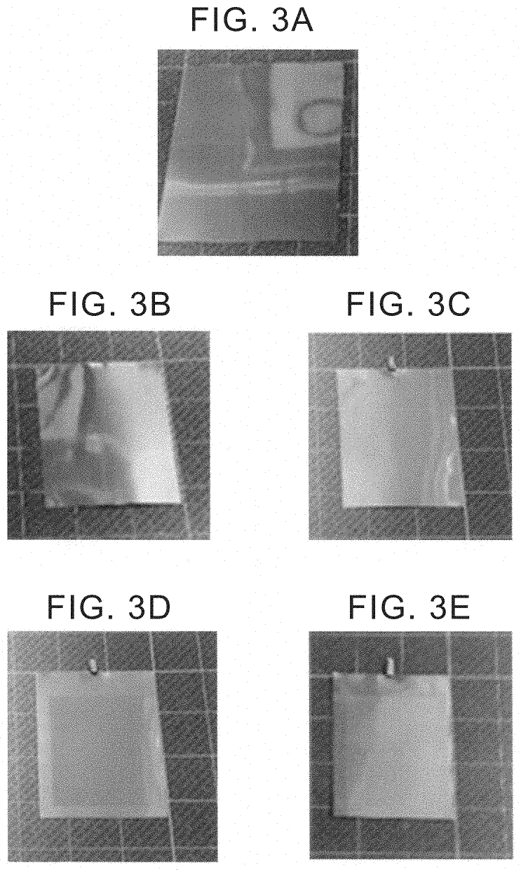

The contact resistance of the test sample prior to the corrosion resistance test and the contact resistance and indium (In) dissolution amounts of the test sample after the corrosion resistance test measured in the corrosion resistance tests 1 to 4 are shown in Table 1 below. FIG. 3A is a photograph of the test sample prior to the corrosion resistance test, and FIGS. 3B to 3E are photographs of the test sample after the corrosion resistance test of corrosion resistance tests 1-4, respectively.

TABLE 1-1

| | | Before | After 1 | Corrosion | After 3 | Corrosion |
|---|---|---|---|---|---|---|
| | | corrosion | corrosion | resistance | corrosion | resistance |
| | Standard | resistance test | resistance test | after 2 tests | resistance tests | after 4 tests |
| pH | | | 6 | 4 | 3 | 2 |
| Contact | <10 | 3 | 6 | 6 | 977 | 10010 |
| resistance | | | | | | |
| (mΩ · cm) | | | | | | |
| In | | | <1 Not | <1 Not | 847 | 2510 |
| dissolved | | | detectable | detectable | | |
| amounts | | | | | | |
| (μg/L) | | | | | | |

As shown in Table 1 and FIGS. 3A to 3E, when pH of the corrosive solution is 4 or more, no discoloration is observed in the test sample after the corrosion resistance test, the contact-resistance can be maintained at a lower value, and In dissolution is undetectable level. On the other hand, when pH of the corrosive solution was less than 4, discoloration was observed in the test sample after the corrosion resistance test, the contact-resistance was remarkably increased, and In dissolution rate was remarkably increased. Further, the test samples after the corrosion resistance test of corrosion resistance tests 1 to 4 were observed visually and by an optical microscope, and it was confirmed that no corrosion of the metal substrate occurred in the test samples after any corrosion resistance test.

### Comparative Example

First, a flat metal substrate made of aluminum was prepared. Next, a conductive oxide film containing indium-tin-oxide (ITO) was formed on one main surface of the metallic substrate to a 100 nm thickness by using a sputtering method. In this case, before forming the conductive oxide film, a natural oxide film or the like on one main surface (film forming surface) of the metal substrate was removed by using an inverse sputtering method in advance. Thus, an anode-side separator was produced.

The anode-side separator prepared in the comparative example was subjected to a corrosion resistance test in the same manner as in the corrosion resistance test 1. Then, the test sample after the corrosion resistance test, as a result of observation by visual and optical microscope, it was confirmed that the corrosion of the metal substrate occurred.

### Reference Example

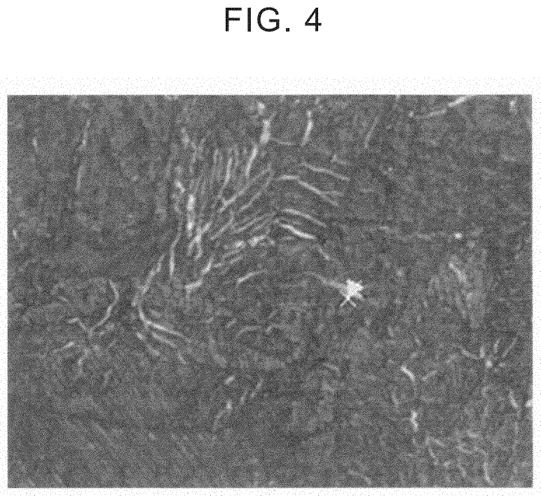

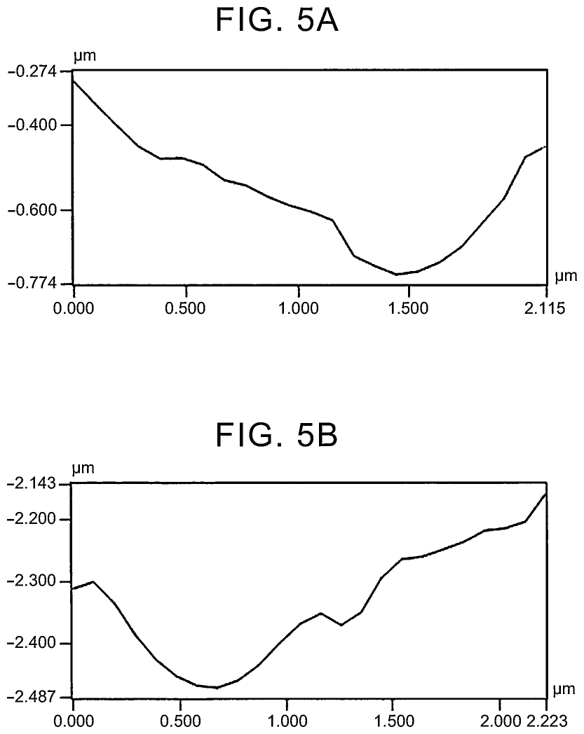

Prepare a metal substrate made of pure titanium used in the preparation of the anode-side separator in the embodiment, when measuring the surface roughness Rz of one main surface of the metal substrate (film-forming surface), the surface roughness Rz was about 0.3 μm. FIG. 4 is an optical micrograph of one principal surface of a plate-shaped metal substrate made of pure titanium used in the preparation of the anode-side separator in Examples. FIGS. 5A and 5B are roughness curves of two portions of one main surface of a plate-shaped metallic substrate made of pure titanium used in the preparation of the anode-side separators in the embodiment.

Although the embodiments of the anode-side separator and the water electrolyzer of the present disclosure have been described in detail above, the present disclosure is not limited to the above-described embodiments, and various design changes can be made without departing from the spirit of the present disclosure described in the claims.

What is claimed is:

1. An anode-side separator used in a water electrolyzer, comprising:
a metal substrate consisting of titanium or stainless steel; and
a conductive oxide film including indium-tin-oxide (ITO) provided on a surface of the metal substrate.

2. A water electrolyzer comprising the anode-side separator according to claim 1.
